(19) United States
(12) Patent Application Publication
(10) Pub. No.: US 2013/0133842 A1
(43) Pub. Date: May 30, 2013

(54) LADDER TAPE FOR WINDOW COVERING AND SLAT ADJUSTING APPARATUS USING THE LADDER TAPE

(71) Applicant: Chen-Hsing LI, Taichung (TW)

(72) Inventor: Chen-Hsing LI, Taichung (TW)

(73) Assignee: NIEN MADE ENTERPRISE CO., LTD., Taichung (TW)

(21) Appl. No.: 13/404,222

(22) Filed: Feb. 24, 2012

(30) Foreign Application Priority Data
Nov. 29, 2011 (TW) 100222565

(51) Int. Cl. E06B 9/303; F16G 11/00

(52) U.S. Cl. 160/170; 24/122.6

(57) ABSTRACT

A ladder tape includes two pairs of warp strings, and two weft strings repeatedly passing through the warp strings in a predetermined way to form two cords and a plurality of bridge sections between the cords. The weft strings respectively are wound around one section of each pair of the warp strings only to form an opening between the warp strings that the ladder tape may engage with the rotary drum of the window blind in a fast and easy way. The weft strings are wound around the warp strings in a way that the ladder tape will not get entangled with other objects unexpectedly.

### BACKGROUND OF THE INVENTION

1. Field of the Invention

The present invention relates generally to a cord and its application, and more particularly to a ladder tape for a window covering and a slat adjusting apparatus of a window blind using the ladder tape.

2. Description of the Related Art

There are lots of ways to weave cords for various purposes of a ladder tape. FIG. 1 and FIG. 2 show a conventional ladder tape 1 for a window blind. The ladder tape 1 includes two parallel cords, each of which has a weft string la and two warp strings 1b, 1c. The weft string 1a winds around the warp strings 1b, 1c in a specific way. The weft string 1a forms several transverse coupling sections 1d to support slats 2 of the window blind (as shown in FIG. 1) and an unwound section 1e (as shown in FIG. 2). The unwound section 1e lets the warp strings 1b, 1c having an unbounded section that an opening 1f is formed between the warp strings 1b, 1c.

As shown in FIG. 2, a pin 3 passes through a gap 1g between the unwound section 1e and the weft string 1b, and then passes through the opening 1f through a path L. The pin 3 has a neck 3a that will be arranged to be located between the warp strings 1b, 1c so that the warp strings 1b, 1c may hold the pin 3. Next, the pin 3 is inserted into a rotary drum 4. The rotary drum 4 has a plate 4a to cover and press the pin 3 thereunder so to fix the pin 3 with the rotary drum 4. The rotary drum 4 is rotated to move the ladder tape 1 and tilt the slats 2.

The conventional apparatus for controlling the slats 2 has the following drawbacks:

1. The ladder tape 1 are fastened to the rotary drum 4 using an additional pin 3 that is difficult to assemble and the ladder tape 1 may be disengaged with the rotary drum 4 easily if the pin 3 becomes loose within the rotary drum 4.

2. The pin 3 is inserted into the gap 1g between the unwound section 1e and the warp string 1b and the opening 1f that will have a risk of breaking the unwound section 1e.

3. The unwound section 1e may be entangled with other objects unexpectedly because it is exposed without any protection.

### SUMMARY OF THE INVENTION

The primary objective of the present invention is to provide a ladder tape, which is not easily entangled with other objects unexpectedly.

According to the objective of the present invention, a ladder tape includes a first warp string, a second warp string, a third warp string, a fourth warp string; and at least two first weft strings repeatedly passing through the warp strings in a predetermined way. The first warp string and the second warp string are wound by a first weft string to form a first cord, and the third warp string and the fourth warp string are wound by the other first weft string to form a second cord. The first weft strings respectively have a plurality of first sections alternately wound around the first warp string and the second warp string, a plurality of second sections alternately wound around the third warp string and the fourth warp string. The first weft strings have a plurality of bridge sections between the first cord and the second cord, and opposite ends of each bridge sections respectively connect to the corresponding first section and the corresponding second section. The first weft strings respectively have a winding section wound around the first warp string to form a first opening between the first warp string and the second warp string, and wound around the third warp string only to form a second opening between the third warp string and the fourth warp string.

The present invention further provides a slat adjusting apparatus of a window blind, including a rotary drum and a ladder tape. The ladder tape has a first warp string, a second warp string, a third warp string, a fourth warp string, and at least two first weft strings repeatedly passing through the warp strings. The first weft strings respectively have a winding section wound around the first warp string to form a first opening between the first warp string and the second warp string, and wound around the third warp string only to form a second opening between the third warp string and the fourth warp string.

In an embodiment, the first warp string and the second warp string are interlaced with each other at a region above and under the first opening, and the third warp string and the fourth warp string are interlaced with each other at a region above and under the second opening.

In an embodiment, the first warp string and the second warp string respectively have a high knitting density section at a region around the first opening, and the third warp string and the fourth warp string respectively have a high knitting density section at a region around the second opening.

In an embodiment, the ladder further includes at least two second weft strings repeatedly passing through the warp strings in a way opposite to the first weft strings, wherein the second weft strings have a plurality of first sections alternately wound around the first warp string and the second warp string, a plurality of second sections alternately wound around the third warp string and the fourth warp string, and a plurality of bridge sections between the first cord and the second cord; wherein opposite ends of the bridge section respectively connect to the corresponding first section and the corresponding second section; and wherein the second weft strings respectively have a winding section wound around the second warp string within the first opening and the fourth warp string within the second opening.

The present invention overcomes the drawbacks of the conventional device. It has no hanging string to get entangled unexpectedly. When the ladder tape of the present invention is mounted on a window blind, it may engage the first and the second openings to the coupling portion of the rotary drum in an easy and fast way.

### BRIEF DESCRIPTION OF THE DRAWINGS

FIG. 1 is a perspective view of the conventional window blind;

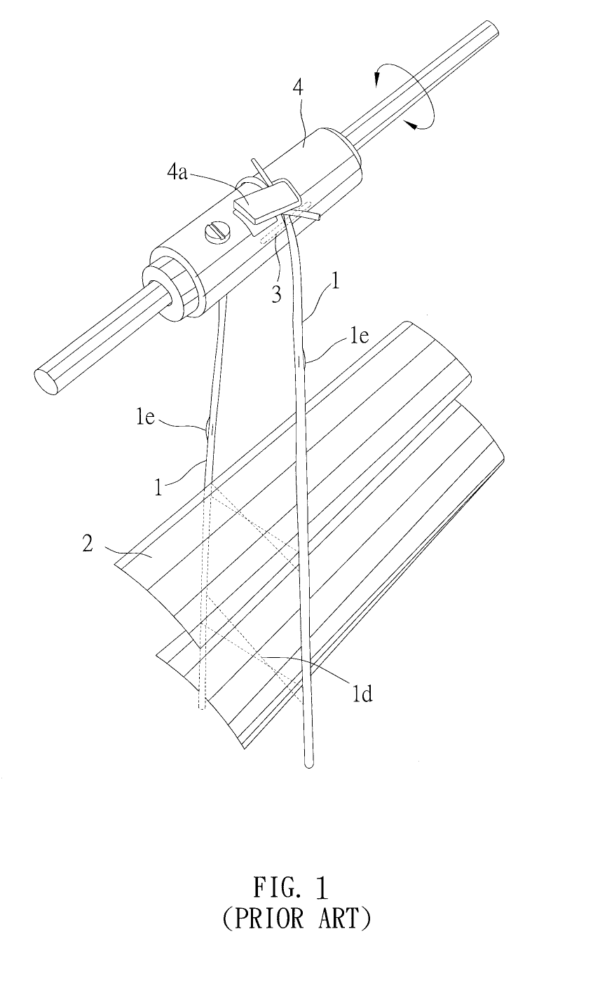

FIG. 2 is a perspective view of the conventional ladder tape and the pin;

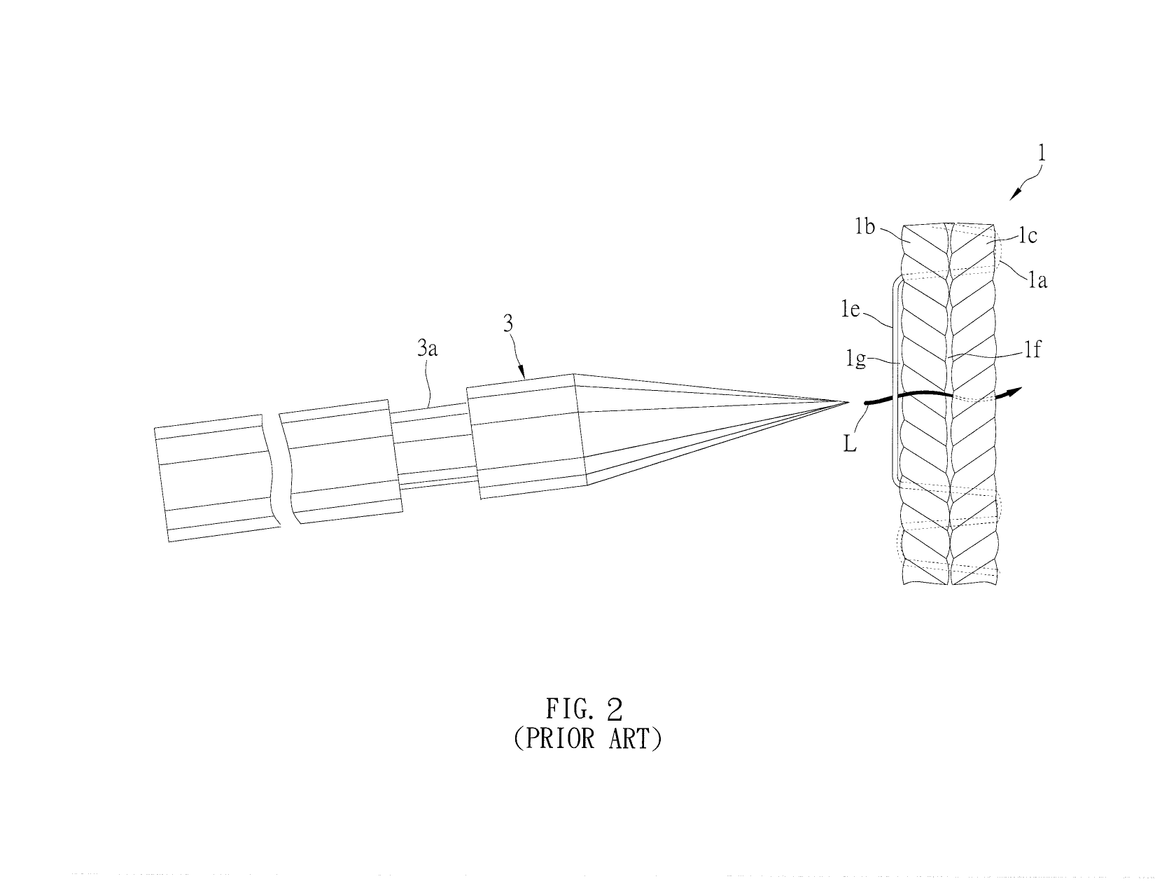

FIG. 3 is a perspective view of the first preferred embodiment of the present invention;

FIG. 4 is a sketch diagram of the ladder tape of the first preferred embodiment of the present invention;

FIG. 5 is a sketch diagram of the ladder tape of a second preferred embodiment of the present invention;

FIG. 6 is a sketch diagram of the ladder tape of a third preferred embodiment of the present invention; and

FIG. 7 is a sketch diagram of the ladder tape of a fourth preferred embodiment of the present invention.

### DETAILED DESCRIPTION OF THE INVENTION

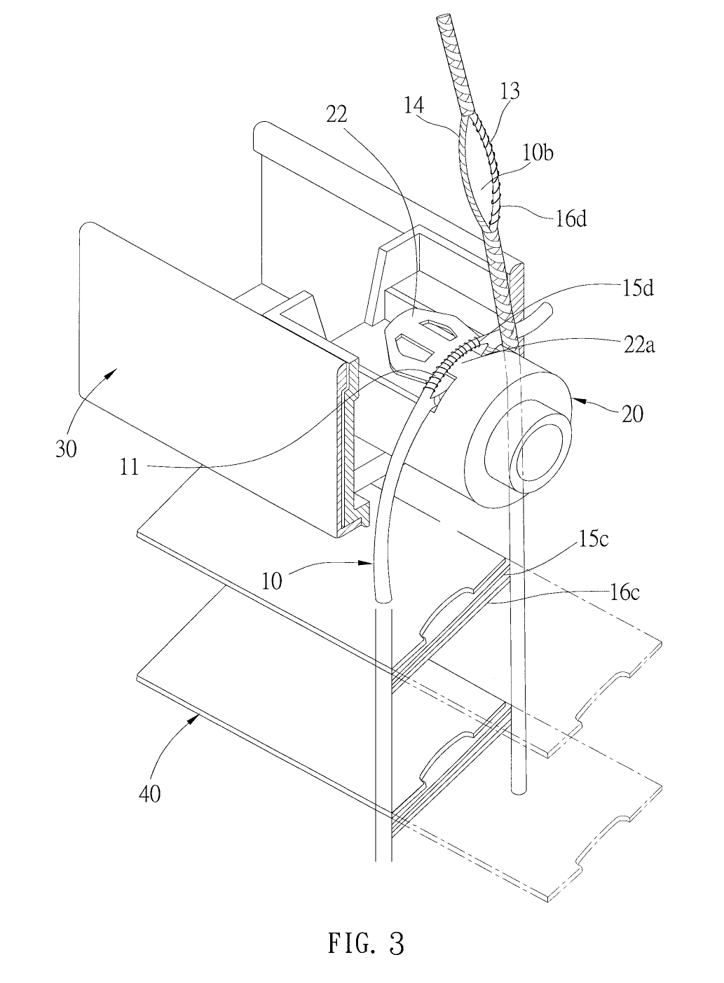

As shown in FIG. 3, a ladder tape 10 of the first preferred embodiment of the present invention is incorporated in a window blind. The window blind has a top rail 30, in which a rotary drum 20 is provided to be turned. In the present invention, the rotary drum 20 is a barrel has a protrusion 22 to form a coupling portion, and the protrusion 22 has a neck 22a. The neck 22a is a thinner portion of the protrusion 22.

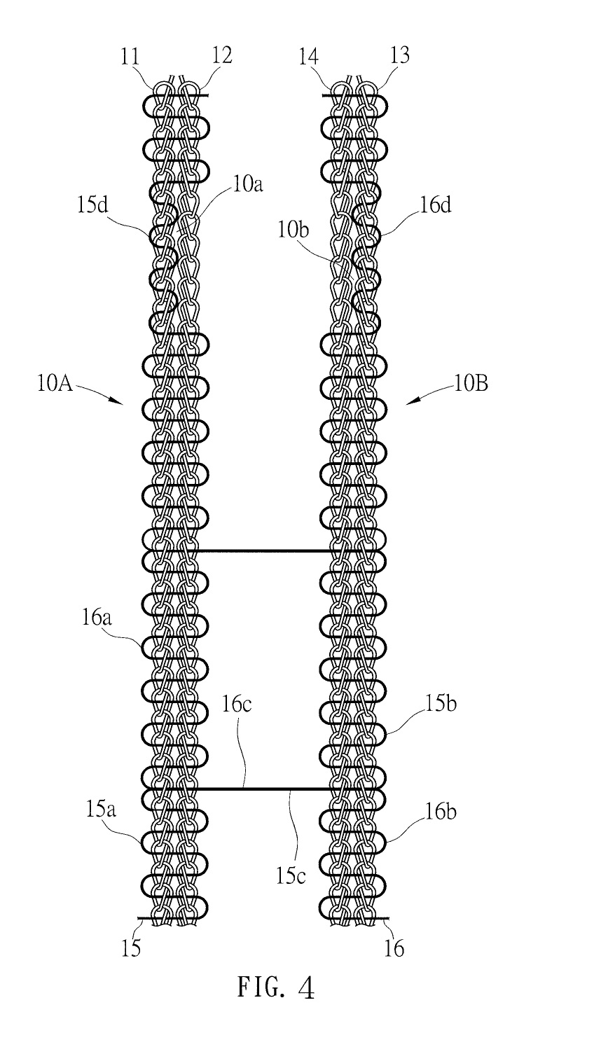

As shown in FIG. 4, the ladder tape 10 of the first preferred embodiment has a first warp string 11, a second warp string 12, a third warp string 13, a fourth warp string 14, and two first weft strings 15, 16. The first weft strings 15, 16 repeatedly pass through the warp strings 11-14 to be wound around the warp strings 11-14 in a predetermined way to form the ladder tape 10. The first weft string 15 repeatedly passes through the first and the second warp strings 11, 12 for a predetermined length, and then goes to the third and the fourth warp strings 13, 14 to repeatedly pass through them for a predetermined length, and then goes back to the first and the second warp strings 11, 12 for the same. The first weft string 16 is opposite to the first weft string 15, it starts from the third and the fourth warp strings 13, 14, goes to the first and the second warp strings 11, 12, and then goes back to the third and the fourth warp strings 13, 14. The first weft strings 15, 16 go between the first and the second warp strings 11, 12 and the third and the fourth warp strings 13, 14 for several times. The first and the second warp strings 11, 12 are wound by the first weft strings 15, 16 to form a first cord 10A, and the third and the fourth warp strings 13, 14 are wound by the first weft strings 15, 16 to form a second cord 10B. The first weft string 15 has a plurality of first sections 15a and second sections 15b, in which the first sections 15a are the parts of the first weft string 15 being wound around the first and the second warp strings 11, 12, and the second sections 15b are the parts of the first weft string 15 being wound around the third and the fourth warp strings 13, 14. The first weft string 16 has a plurality of first sections 16a and second sections 16b, in which the first sections 16a are the parts of the first weft string 16 being wound around the first and the second warp strings 11, 12, and the second sections 16b are the parts of the first weft string 16 being wound around the third and the fourth warp strings 13, 14. Therefore, on the first cord 10A has alternate the first sections 15a, 16a, and on the second cord 10B has alternate the first sections 15b, 16b. The first weft strings 15, 16 form several bridge sections 15c, 16c between the first cord 10A and the second cord 10B to support slats 40.

The first weft string 15 further has a winding section 15d which is wound around the first warp string 11 only, and the first weft string 16 further has a winding section 16d which is wound around the third warp string 13 only. Consequently, the first cord 10A has a first opening 10a between the first and the second warp strings 11, 12 beside the winding section 15d, and the second cord 10B has a second opening 10b between the third and the fourth warp strings 13, 14 beside the winding section 16d. The first cord 10A and the second cord 10B are fastened to the rotary drum 20 by engaging the first and the second openings 10a, 10b of the first cord 10A and the second cord 10B to the protrusion 22 of the rotary drum 20. The first cord 10A and the second cord 10B will be rested in the neck 22a of the protrusion 22.

The present invention has the following advantages:

1. No fastener (such as the pin of the prior art) is needed to connect the ladder tape to the window blind. It only needs to fit the first and the second openings 10a, 10b of the ladder tape 10 to the protrusion 22 of the rotary drum 20.

2. The first weft strings 15, 16 have the winding sections 15d, 16d wound around the corresponding warp strings within the first and the second openings 10a, 10b. It will help the first and the second cords 10A, 10B to form the first and the second openings 10a, 10b, and furthermore, there is no hanging string besides the opening that the ladder tape 10 of the present invention will not get entangled unexpectedly.

3. The first and the second openings 10a, 10b are not formed by cutting the cords 10A, 10B. They are formed naturally after the warp strings 11-14 being wound by the first weft strings 15, 16. Besides, the first and the second openings 10a, 10b are between the warp strings that the ladder tape 10 is strong enough to hold the slats when the first and the second openings 10a, 10b are fit to the protrusion 22 of the rotary drum 20.

The following embodiments provide different structures to enhance the strength of the first and the second openings 10a, 10b of the ladder tape 10.

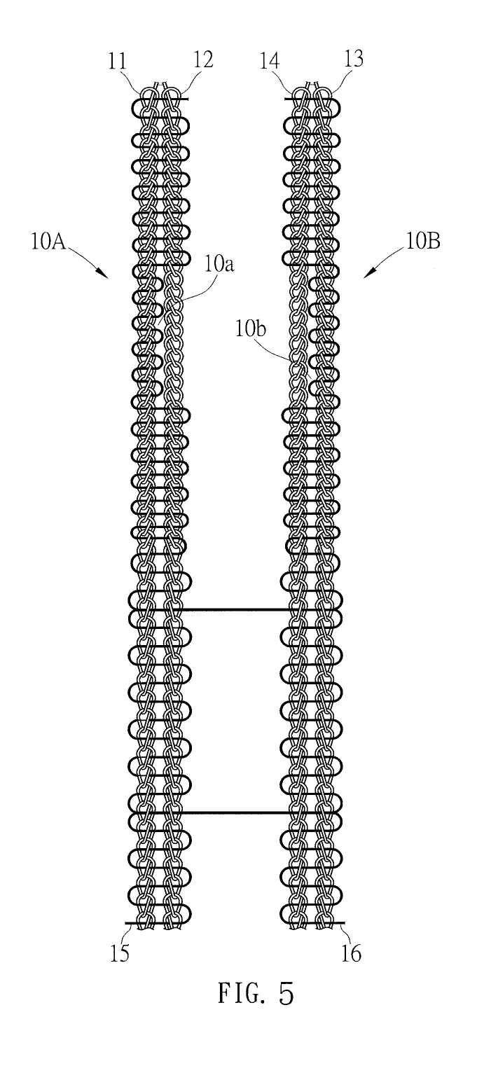

FIG. 5 shows a ladder tape of the second preferred embodiment of the present invention. The warp strings 11 to 14 have different knitting intensities in different parts. The warp strings 11 to 14 respectively have a high knitting density section around the first and the second openings 10a, 10b, in other words, the knitting densities around the first and the second openings 10a, 10b are higher than the rest pars of the warp strips 11 to 14. Also, the first weft strings 15, 16 can have longer sections, thus denser knitting, wound around the high density sections, and therefore, the strengths around the first and the second openings 10a, 10b increase. As a result, the portions around the openings 10a, 10b are stronger.

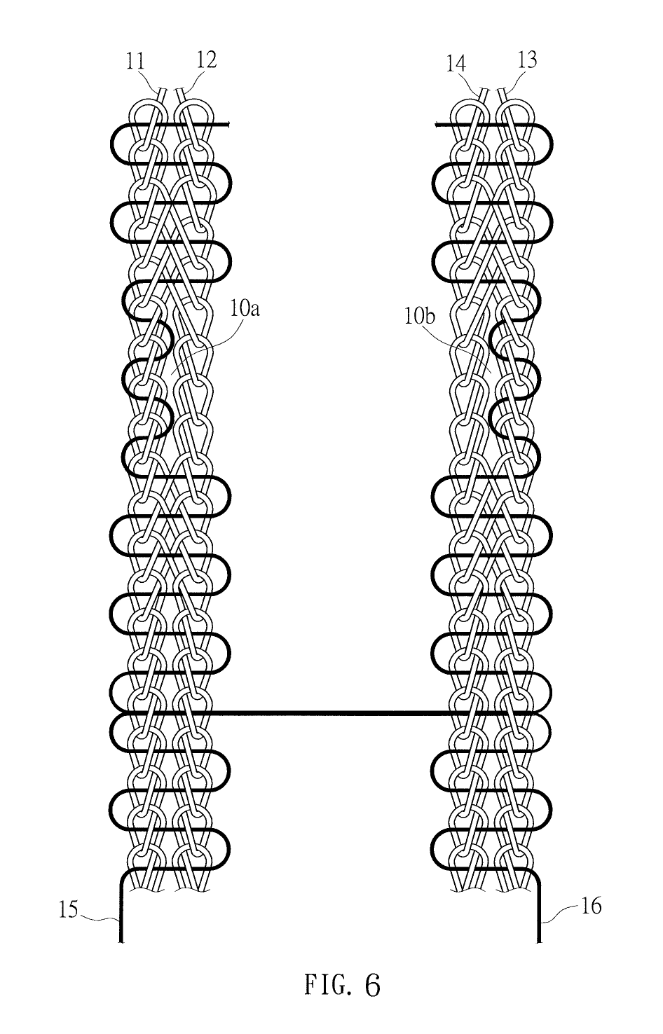

FIG. 6 shows a ladder tape of the third preferred embodiment of the present invention. The first warp string 11 and the second warp string 12 are interlaced with each other at a region above and under the first and the second openings 10a, and the third warp string 13 and the fourth warp string 14 are interlaced with each other at a region above and under the first and the second openings 10b. It enhances the strength of the first and the second openings 10a, 10b as well.

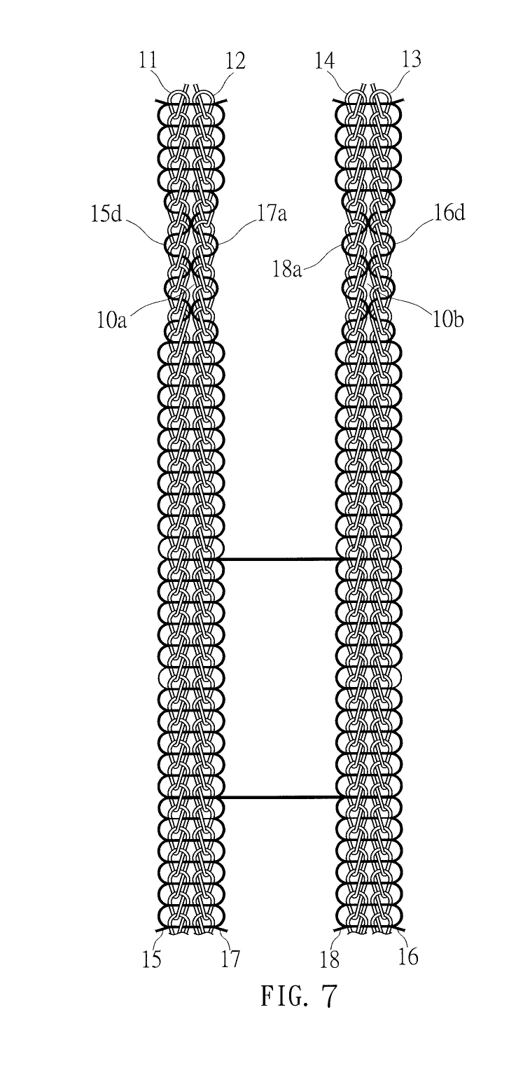

As shown in FIG. 7, a ladder tape of the fourth preferred embodiment of the present invention further includes a pair of second weft strings 17, 18. The second weft strings 17, 18 repeatedly pass through the warp strings 11-14 to be wound around the warp strings 11 to 14 in a way opposite to the first weft strings 15, 16 respectively. Therefore, the sections of the warp strings 11 to 14 within the first and the second openings 10a, 10b are respectively wound by the first and the second weft strings 15 to 18. Precisely, the first and the second warp strings 11 and 12 within the first opening 10a are wound by the winding sections 15a and 17a of the first weft strings 15 and the second weft strings 17, and the third and the fourth warp strings 13 and 14 within the second opening 10b are wound by the winding sections 16a and 18a of the first weft strings 16 and the second weft strings 18. It enhances the total strength of the ladder tape.

The description above is a few preferred embodiments of the present invention and the equivalence of the present invention is still in the scope of claim construction of the present invention.

What is claimed is:

1. A ladder tape, comprising:
a first warp string, a second warp string, a third warp string, and a fourth warp string; and
at least two first weft strings repeatedly passing through the warp strings in a predetermined way;
wherein the first warp string and the second warp string are wound by the first weft strings to form a first cord, and the third warp string and the fourth warp string are wound by first weft strings to form a second cord;
wherein the first weft strings respectively have a plurality of first sections alternately wound around the first warp string and the second warp string, a plurality of second sections alternately wound around the third warp string and the fourth warp string;
wherein the first weft strings have a plurality of bridge sections between the first cord and the second cord, and opposite ends of each bridge sections respectively connect to the corresponding first section and the corresponding second section;
wherein the first weft strings respectively have a winding section wound around the first warp string to form a first opening between the first warp string and the second warp string, and wound around the third warp string only to form a second opening between the third warp string and the fourth warp string.

2. The ladder tape as defined in claim 1, wherein the first warp string and the second warp string are interlaced with each other at a region above and under the first opening, and the third warp string and the fourth warp string are interlaced with each other at a region above and under the second opening.

3. The ladder tape as defined in claim 1, wherein the first warp string and the second warp string respectively have a high density section at a region around the first opening, and the third warp string and the fourth warp string respectively have a high density section at a region around the second opening.

4. The ladder tape as defined in claim 1, further comprising at least two second weft strings repeatedly passing through the warp strings in a way opposite to the first weft strings, wherein the second weft strings have a plurality of first sections alternately wound around the first warp string and the second warp string, a plurality of second sections alternately wound around the third warp string and the fourth warp string, and a plurality of bridge sections between the first cord and the second cord; wherein opposite ends of the bridge section respectively connect to the corresponding first section and the corresponding second section; and wherein the second weft strings respectively have a winding section wound around the second warp string within the first opening and the fourth warp string within the second opening.

5. A slat adjusting apparatus of a window blind, comprising:
a rotary drum having a coupling portion; and
a ladder tape having a first warp string, a second warp string, a third warp string, a fourth warp string, and at least two first weft strings repeatedly passing through the warp strings;
wherein the first weft strings respectively have a winding section wound around the first warp string and the third warp string only to form a first opening between the first warp string and the second warp string, and a second opening between the third warp string and the fourth warp string;
wherein the coupling portion of the rotary drum engages the first opening and the second opening to connect the ladder tape to the rotary drum.

6. The slat adjusting apparatus as defined in claim 5, wherein the coupling portion of the rotary drum has a protrusion with a neck, and the first opening and the second opening of the ladder tape are fitted to the protrusion and rested in the neck.

7. The slat adjusting apparatus as defined in claim 5, wherein the first warp string and the second warp string are interlaced with each other at a region above and under the first opening, and the third warp string and the fourth warp string are interlaced with each other at a region above and under the second opening.

8. The slat adjusting apparatus as defined in claim 5, wherein the first warp string and the second warp string are wound by the first weft strings to form a first cord, and the third warp string and the fourth warp string are wound by first weft strings to form a second cord; wherein the first weft strings have a plurality of first sections alternately wound around the first warp string and the second warp string, a plurality of second sections alternately wound around the third warp string and the fourth warp string, and a plurality of bridge sections between the first cord and the second cord, and opposite ends each of the bridge sections respectively connect to the corresponding first section and the corresponding second section.

9. The slat adjusting apparatus as defined in claim 8, wherein the first warp string and the second warp respectively have a high density section at a region around the first opening, and the third warp string and the fourth warp string respectively have a high density section at a region around the second opening.

10. The slat adjusting apparatus as defined in claim 5, further comprising at least two second weft strings repeatedly passing through the warp strings in a way opposite to the first weft strings, wherein the second weft strings have a plurality of first sections alternately wound around the first warp string and the second warp string, a plurality of second sections alternately wound around the third warp string and the fourth warp string, and a plurality of bridge sections connect to the corresponding first sections and the corresponding second sections; and wherein the second weft strings respectively have a winding section wound around the second warp string within the first opening and the fourth warp string within the second opening.
